(19) United States
(12) Patent Application Publication
(10) Pub. No.: US 2007/0079861 A1
(43) Pub. Date: Apr. 12, 2007

(54) Solar rail or railing system

(76) Inventor: Anthony Morali, New York, NY (US)

Correspondence Address: LADAS & PARRY, 26 WEST 61ST STREET, NEW YORK, NY, 10023, US

(21) Appl. No.: 10/576,380

(22) PCT Filed: Nov. 12, 2004
(86) PCT No.: PCT/US04/37980

§ 371 Date: Apr. 19, 2006

Related U.S. Application Data
(60) Provisional application No. 60/519,238, filed on Nov. 12, 2003.

(51) Int. Cl. H02N 6/00

(52) U.S. Cl. 136/244

(57) ABSTRACT

A panel for a solar rail or railing system has first and second transparent or, at least, translucent tempered glass panels, an array of solar cells (24) spaced from but connected to each other on a transparent or, at least, translucent film sandwiched between the glass panels, a bottom rail (22) for supporting the sandwich of film and glass panels from a portion of a building, and a top rail (20) for an outlet conduit of the electrical connection of the solar cells.

### BACKGROUND OF THE INVENTION

The invention relates to locating photovoltaic units such as solar cells in a rail or railing system, for example as balustrade panels above, below or between connecting rails extending, for example, horizontally about high-rise balconies.

Resource conservation, environmental concerns and other energy costs have promoted interest in photovoltaic technology that converts light and, preferably, sunlight into electricity. Two problems with this have been encountered. One is that present solar cells produce only small amounts of electricity, so that large areas need to be covered with solar cells to generate meaningful supplies of electricity. Is these large areas are located in remote areas where the space is cheap, then transmission costs create a second problem in conducting the electricity to a location for use.

Therefore, it has been considered to put solar cells on the otherwise unused space of building roofs. Such locations are difficult and dangerous to access. Moreover, when the roof is that of a high-rise building, the area of roof that may receive solar cells relative to the volume of building that needs electric supply is too limited, even when the building roof is designed to receive the solar cells like the CitiCorp building in New York City.

As a result, other locations for solar cells have been proposed. For example, Sinha, et al. U.S. Patent Application Publication 2004/0139689 of Jul. 22, 2004 discloses the use of existing building structures such as fences for installing solar electric panels or, instead of pre-existing building structures, installing solar electric panels on structures that can be put together easily, such as gazebos, patio covers or window awnings. Pre-fabricated aluminum rails or wooden plates are screwed onto top surfaces of such structures and solar electric panels are mounted on these rails or plates, whereby such rails are like laths, and not rails of a railing.

For another example, Lund-Hansen U.S. Pat. No. 6,384,314 is based on the consideration that there are certain building parts which, with full architectonical accept, may appear with pronounced slanting orientation, viz. Sun shading lamellae mounted outside windows with strong sun infall. Hereby, the traditional conception of solar cell panels as independent, concentrated plate elements should be left behind, as instead elongate and relative narrow carriers are used for the purpose, e.g. with a width of only 10-20 cm and moreover of such a type which, at the outset, also serves a different purpose, viz. sun shading.

There are, however, many architectural elements for which panels are better suited than lamellae, pickets or rail/balusters and which, at the outset, also serve a different purpose than sun shading. For example, Lyons U.S. Pat. No. 6,425,676 discloses an outdoor railing system that could utilize pickets or plates of transparent material beneath a connecting rail. The plates or panels are transparent and illuminated, for example, by electrical connection or lighting from the rail. Such transparent panels in a railing system provide windbreak while retaining the advantages of security and view of lamellae, picket or rail/balustrade railing systems, which make them popular for high-rise balconies, for example.

### SUMMARY OF THE INVENTION

Therefore, the invention combines the interest in photovoltaic technology, with available space at a location of energy use as a rail or railing system for a building. In particular, the rail or railing system may be used about high-rise balconies. The rail or railing system has one or more solar panels above, below or between a bottom, top or bottom and top rails that provide support to each panel and connection between panels.

In particular, a panel for a solar rail or railing system has first and second transparent or, at least, translucent tempered glass panels, an array of solar cells spaced from but connected to each other on a transparent or, at least, translucent film sandwiched between the glass panels, a bottom rail for supporting the sandwich of film and glass panels from a portion of a building, and a top rail for an outlet conduit of the electrical connection of the solar cells.

### BRIEF DESCRIPTION OF THE DRAWINGS

Preferred embodiments that illustrate but do not limit the invention are now described with reference to drawings in which:

FIG. 1 is a front elevational view of a first embodiment of panel sections of a solar rail or railing system according to the invention on an inhabited building;

FIG. 2 is an exploded front elevational view of one of the panel sections of the solar rail or railing system of FIG. 1;

FIG. 3 is a front elevational view of the panel section of FIG. 2 in schematic combination with other elements of the solar rail or railing system;

FIG. 4 is a top plan view of a second embodiment of panel sections of a solar rail or railing system according to the invention on a projecting balcony for a building;

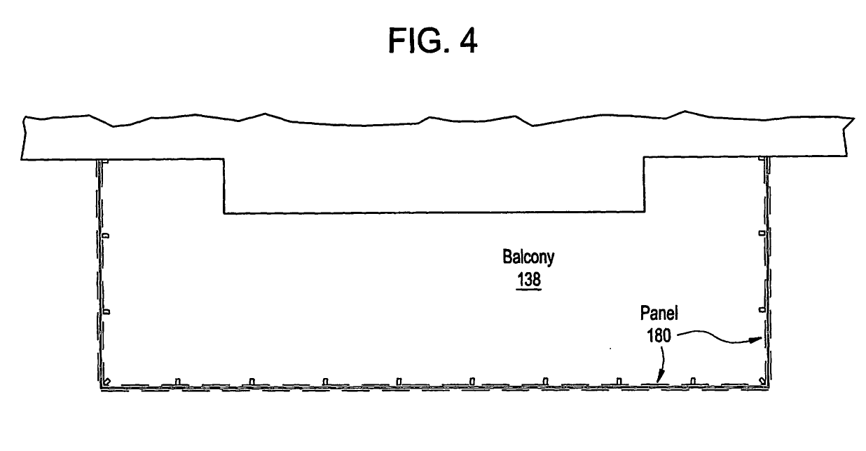

FIG. 5 is elevational and plan views of the panel sections of FIG. 4;

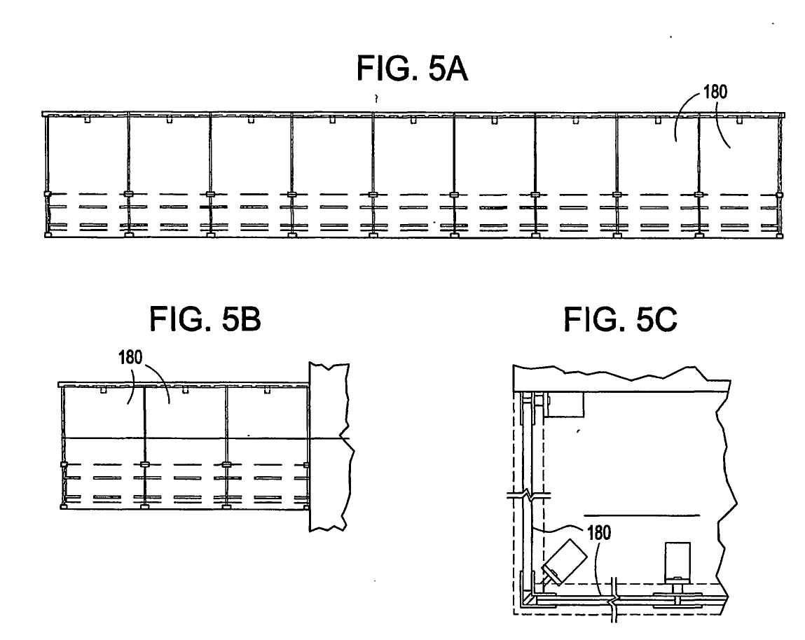

FIG. 6 is a sectional elevational view of a portion of the panel sections of FIG. 4 and a portion of the projecting balcony and building thereof;

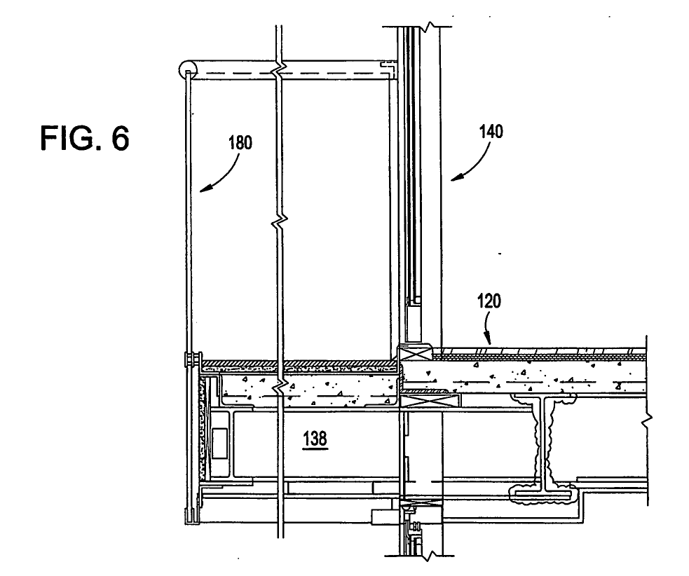

FIG. 7 is a cross sectional elevation of a zee-cup connection for mounting a third embodiment of a panel 280 on a balcony 238;

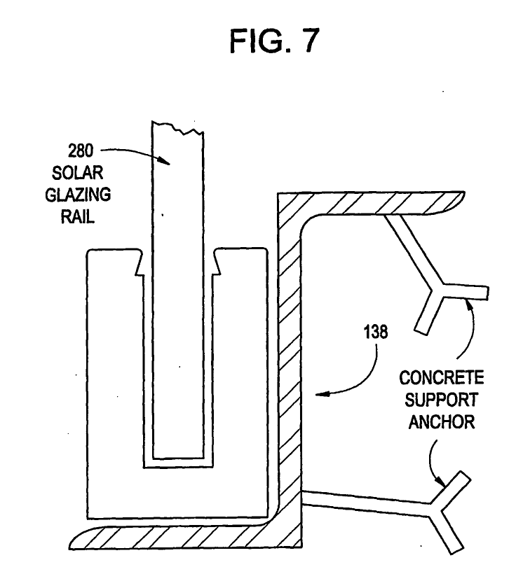

FIG. 8 is a front elevational view of a fourth embodiment of panels 380 on a building 320; and

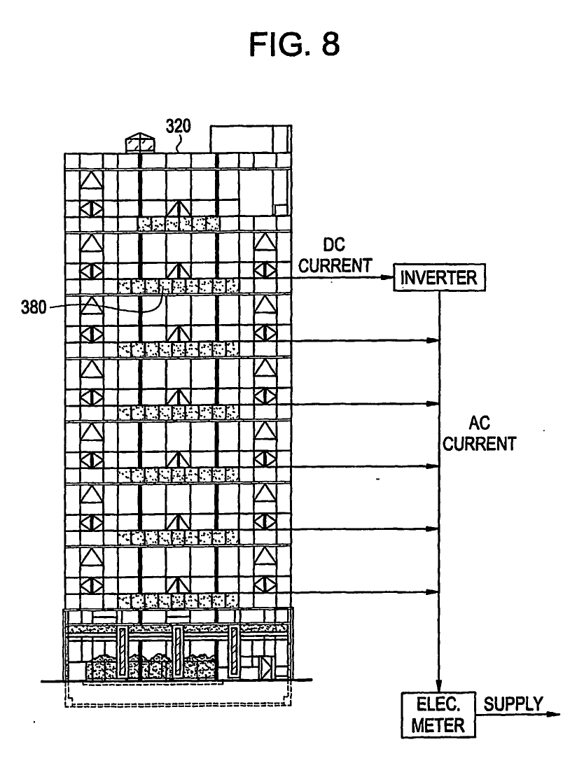

FIG. 9 is a cross sectional side elevational view of a portion of the fourth embodiment.

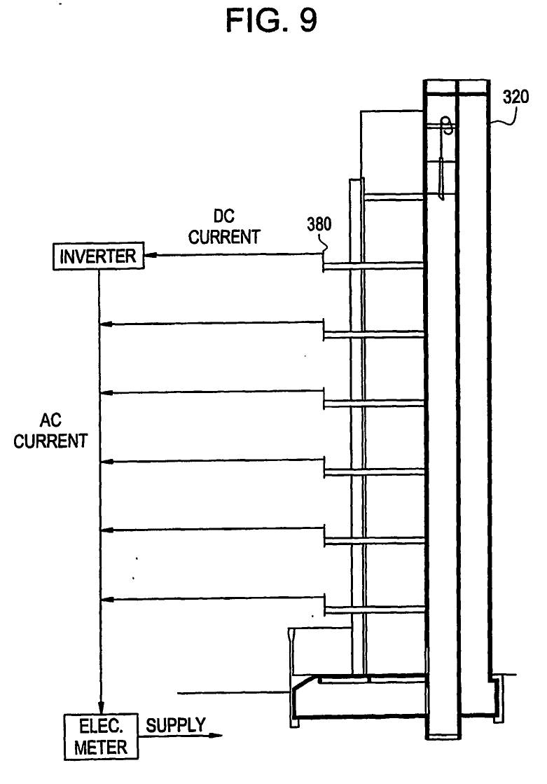

### DESCRIPTION OF PREFERRED EMBODIMENTS

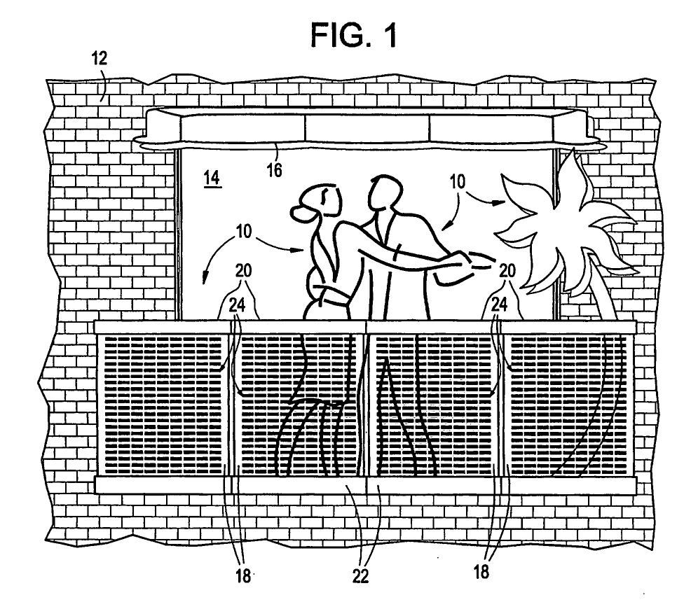

In FIG. 1, people and plants at 10 stand on a projecting balcony (not shown) of a building portion 12. An entry 14 from the balcony into the building may be shaded by an awning 16 but, as general in such cases, the awning would not project far enough from the building to shade as well panel sections 18 about a perimeter of the balcony as part of a solar rail or railing system.

The panel sections have respective top rail sections 20 and bottom rail sections 22. The top rail sections interconnect to form a top rail element or handrail and the bottom rail sections interconnect to form a bottom rail element all along the panel sections for structural strength. The bottom rail element or footing provides a stable support for the panel sections and secures the panel sections to a building structure such as the balcony or terrace, which is behind it in this embodiment and, therefore, not shown.

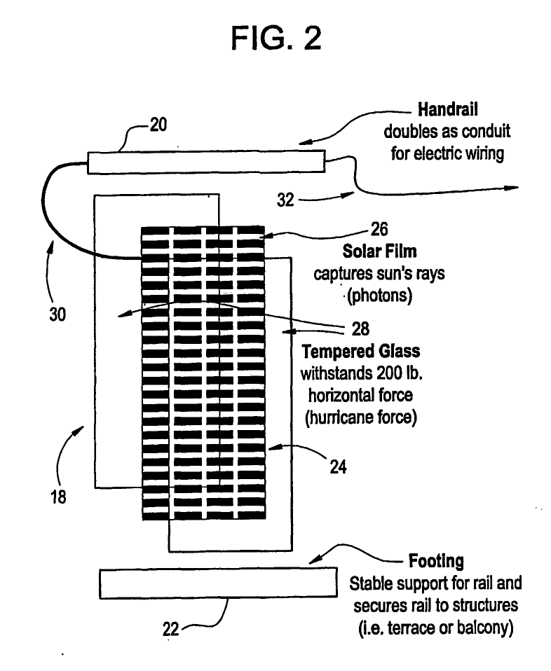

The panel sections have respective arrays of discrete, opaque solar cells at 24 physically spaced from each other but electrically connected to each other. As shown for one of the panel sections 18 in FIG. 2, each of the panel sections has a transparent or, at least, translucent solar film 26 that supports and connects the array of solar cells 24. The solar film 26 is sandwiched between transparent or, at least, translucent tempered glass plates 28, whereby the body of the panel between the top and bottom rail sections remains substantially transparent or, at least translucent despite the array of opaque solar cells.

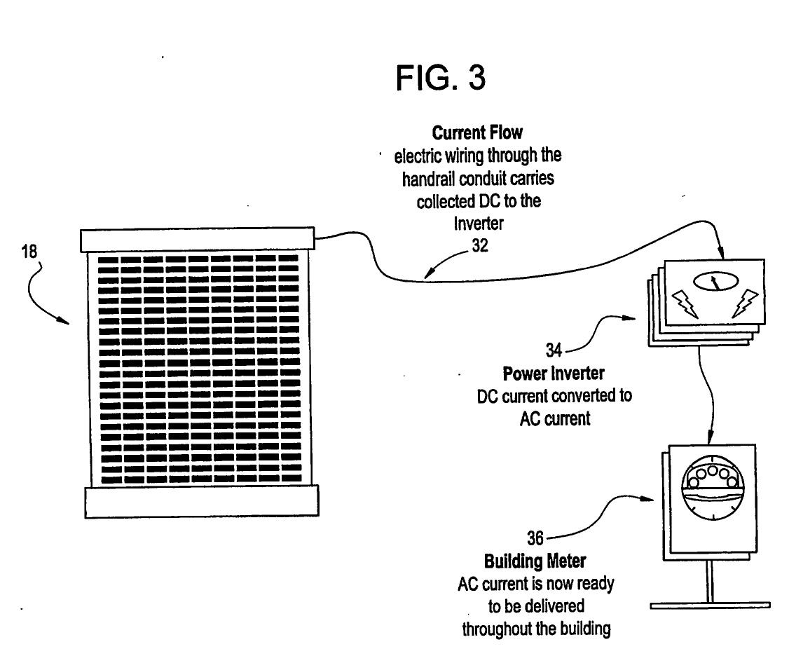

The connected solar cells of the array are connected at 30 to conduction means (not shown) that run through the top rail section that, therefore, doubles as a conduit for such electrical wiring for connection at 32 to other portions of the solar rail or railing system shown in FIG. 3. As shown in FIG. 3, the connection for current flow at 32 carries DC current that the solar cells produce from electric wiring through the handrail conduit to a power inverter at 34. The power inverter converts the DC current into AC current for use, for example through a meter at 36 that delivers the AC current throughout the building.

As thus described, the invention of the above first preferred embodiment lies in the panels 18, the use of such panels as rails or railings on architectural features such as balconies and terraces of buildings and, preferably, high-rise buildings having many thereof, and the system of the panels and power conversion and distribution therefrom.

The second embodiment shows the balcony 138 on which panels at 180 of the solar rail or railing system may be used and a portion of the building 140 from which the balcony projects. Those in the art will understand the second embodiment from the description of the first embodiment and, therefore, description it further to that of the U.S. Provisional Patent Application is omitted. The description of it of the U.S. Provisional Patent Application includes:

The solar rail or railing system is an integrated environmental system utilizing the benefits of thin film photovoltaic technology and structural glazing systems in order to create a fusion system that will become a balcony, terrace or guard rail and a supplemental energy provider.

Technically, the systems range in size in both wattage and the number of panels being used. Components beyond the photovoltaic modules can consist of but not be limited to disconnect switches, combiner boxes, fuses, breakers, DC to AC inverters and miscellaneous wire, conduit and fittings. System designs are replicable but site specific electrical engineering will be part of the services provided to any potential user.

The rail systems can use various types of photovoltaic technologies depending on aesthetic and power requirements. Thin film technology is a silicon (usually amorphous silicon) sprayed onto a substrate of glass or metal, to create a PV (photovoltaic) module. Crystal and poly-crystal PV technologies use wafers of silicon stringed together on the substrate of glass to create a PV module.

The PV modules are placed in direct sunlight to produce DC electricity without noise or pollution. This power (voltage and the roof or average) can feed batteries or be converted directly into AC power that is conditioned to meet the needs of any building requiring electricity. This power can fulfill all or supplement the power to the building.

The advantages of utilizing solar energy are many. Solar energy is produced without noise or pollution, helps reduce the demand for power thus helping utility networks from being overloaded, increases energy security through the distribution of power sources, creates local jobs and helps reduce our dependence on fossil fuels for power generation.

If the solar radial system is an integrated system of the components: 1) photovoltaic: film in between two layers of tempered glass; 2) anchor plans: for connection to structural frames; 3) aluminum or stainless-steel top rail: forms an electrical conduit for direct current to mains; and 4) perforated solar film: allows the diffusion of light through glass panel. Typically, photovoltaic panels are applied to roofs of buildings or freestanding objects. The solar rail system is part of a wall system enclosing a habitable space. The solar rail system has to meet all the relevant criteria of local and national safety and structural resistance to applied horizontal and lateral forces. Further applications apply the solar rail system as a window, wall or curtain wall system. The solar rail system provides for enclosure of volumes of space, weather resistance, protection of interior habitable occupants and light to be transfused at the same time while providing an energy source.

1. A panel for a solar rail or railing system, comprising:
first and second transparent, or, at least, translucent tempered glass panels;
an array of solar cells spaced from but connected to each other on a transparent or, at least translucent film sandwiched between the glass panels;
a bottom rail for supporting the sandwich of film and glass panels from a portion of a building; and
a top rail for an outlet conduit of the electrical connection of the solar cells.

2. The panel according to claim 1, and another thereof with the bottom and top rails respectively connected to each other as bottom and top rail elements.

3. The panel according to claim 1, wherein the top rail forms a handrail.

4. The panel according to claim 2, wherein the top rail element forms a handrail.

5. The panel according to claim 1, wherein the outlet conduit of the top rail is electrically connected to the building.

6. The panel according to claim 2, wherein the outlet conduit of the top rail is electrically connected to the building.

7. The panel according to claim 3, wherein the outlet conduit of the top rail is electrically connected to the building.

8. The panel according to claim 4, wherein the outlet conduit of the top rail is electrically connected to the building.

9. A panel for a solar rail or railing system, comprising:
first and second transparent or, at least, translucent tempered glass panels;
an array of solar cells spaced from but electrically connected to each other on a transparent or, at least, translucent film sandwiched between the glass panels;
a member for supporting the sandwich of film and glass panels from a portion of a building; and
an outlet electrically connected to the electrical connection of the solar cells.

10. The panel according to claim 9, wherein at least one of the member is a bottom rail supporting the bottom of the sandwich or the outlet comprises a conduit in a top rail along a top of the sandwich.

11. The panel according to claim 10, wherein the top rail forms a handrail.

12. The panel according to claim 10, wherein the outlet comprises a conduit in at least one of the top and bottom rails.

13. The panel according to claim 11, wherein the outlet comprises a conduit in at least one of the top and bottom rails.

14. The panel according to claim 9, wherein the outlet is electrically connected to the building.

15. The panel according to claim 10, wherein the outlet is electrically connected to the building.

16. The panel according to claim 11, wherein the outlet is electrically connected to the building.

17. The panel according to claim 12, wherein the outlet is electrically connected to the building.

18. The panel according to claim 13, wherein the outlet is electrically connected to the building.
